(19) United States
(12) Patent Application Publication
(10) Pub. No.: US 2023/0323965 A1
(43) Pub. Date: Oct. 12, 2023

(54) ROTARY VALVE

(71) Applicant: TI Automotive Technology Center GmbH, Rastatt (DE)

(72) Inventors: Albert BOECKER, Ettlingen (DE); Matthias WINTER, Rastatt (DE); Thorsten SCHAEFER, Steinfeld (DE); Florian DEIBEL, Sinzheim (DE); Matthias Bernhard OLBRICH, Rastatt (DE); Artem TUZIN, Stutensee (DE)

(21) Appl. No.: 18/125,077

(22) Filed: Mar. 22, 2023

(30) Foreign Application Priority Data
Mar. 28, 2022 (EP) 22164837.1

(51) Int. Cl. F16K 31/04; F16K 11/085

(52) U.S. Cl. CPC F16K 11/0856; F16K 31/041

(57) ABSTRACT

A rotary valve, comprising a valve housing with a valve chamber, wherein the valve chamber has a chamber wall in which at least two fluid openings are provided, wherein the valve chamber has a receiving opening on the end face side, wherein the valve chamber accommodates a valve core, wherein the valve core is provided with a channel structure which interacts with the fluid openings, wherein the valve core is supported in the valve chamber in a rotationally movable manner, wherein the valve core is continuously rotatable.

### RELATED APPLICATIONS

The present disclosure claims priority to and the benefit of European Application 22164837.1, filed on Mar. 28, 2022, the entire contents of each of which are incorporated herein by reference.

### FIELD

The present disclosure relates to a rotary valve, comprising a valve housing with a valve chamber, wherein the valve chamber has a circumferential wall in which at least two fluid openings are provided, wherein the valve chamber has a receiving opening on the end face side, wherein the valve chamber accommodates a valve core, wherein the valve core is provided with a channel structure which interacts with the fluid openings, wherein the valve core is supported in the valve chamber in a rotationally movable manner.

### BACKGROUND

Such a rotary valve is known, for example, from DE 10 2018 009 680 A1. Rotary valves of this type are often used in cooling circuits to control the flow of coolant. A cooling fluid can flow in and out through the fluid openings provided in the valve housing. The channel structure provided in the valve core controls the coolant flow, wherein, depending on the design and number of fluid openings, different cooling circuits can be activated, the volume flow can be regulated or the flow direction can be adjusted.

The design as a rotary valve is advantageous because the coolant flow is adjusted by rotating the valve core, wherein the corresponding actuator for rotating the valve core is designed in a simple manner and can be easily controlled. Accordingly, rotary valves and the associated actuators can be manufactured in a cost-effective manner. In addition, rotary valves only require a small installation space.

It is also known to form the elements of the rotary valve from plastic. However, it could be problematic that high frictional forces and thus increased wear occur in the case of a sealing contact between the valve core and the valve housing due to the required contact pressure. If, on the other hand, the valve core is arranged in the valve housing with clearance, the forces required for rotation and the wear are reduced, but undesirable leakage may occur via the gap between the valve housing and the valve core.

Such rotary valves are particularly advantageous with regard to use in temperature control circuits in the field of electromobility. To achieve a high range for electric vehicles, for example, it is necessary to control the temperature of electrical components. Electric vehicle components whose temperatures need to be controlled are in particular batteries, but also the power electronics or plug connections of fast charging devices. A battery has a best possible capacity only in a very small temperature spectrum. Therefore, it is necessary to heat batteries of electric vehicles at low ambient temperatures and to cool them at high outside temperatures or at a high load demand.

For this purpose, it is known to provide a temperature control circuit through which a temperature control medium flows. Depending on the requirements, the temperature control medium can either be heated in a heating device or cooled in a cooling device. The flow of the temperature control medium can be controlled by rotary valves.

### BRIEF SUMMARY

The present disclosure is based on the task of providing a rotary valve which is inexpensive and allows for volume flows which can be adapted to requirements.

This task is solved by the features of claim 1. The subclaims refer to advantageous embodiments.

The rotary valve according to the present disclosure comprises a valve housing with a valve chamber, wherein the valve chamber has a circumferential wall in which at least two fluid openings are provided, wherein the valve chamber has a receiving opening on the end face side, wherein the valve chamber accommodates a valve core, wherein the valve core is provided with a channel structure which interacts with the fluid openings, wherein the valve core is supported in the valve chamber in a rotationally movable manner, wherein the valve core is continuously rotatable.

According to the present disclosure, the channel structure can establish a flow-conducting connection between fluid openings, close fluid openings and, due to its continuous rotatability, intermediate positions are also possible in which fluid openings are only partially connected in a flow-conducting manner. This allows volume flows to be varied almost continuously.

By rotating the valve core, the flow-conducting connection between the channel structure and the fluid opening can be changed proportionally, preferably within predetermined intervals. Due to the continuously rotatable valve core, the rotary valve forms a proportional valve, wherein the fluid openings can be fully open, fully closed or partially open by rotation of the valve core. Depending on the design of the channel structure and the position of the valve core relative to the valve housing, the possibility of continuous rotatability of the valve core allows fluid openings to be only partially open, so that the volume flow is reduced. Furthermore, it is possible that a volume flow entering the valve core through a fluid opening is divided into several partial volume flows, wherein the partial volume flows leave the valve core via several fluid openings.

Several fluid openings can be provided in the chamber wall, wherein fluid openings can optionally be brought into flow-conducting communication with one another by rotation of the valve core. The rotary valve can form a directional control valve and divert volume flows between the fluid openings or divide volume flows into partial volume flows.

In particular in the context of a temperature control circuit of a vehicle, it is conceivable, for example, that various components of the vehicle are connected to the temperature control circuit, wherein the temperature control requirements of the components can vary greatly depending on the operating state. Electric vehicles, for example, are equipped with electric motors, rechargeable batteries and power electronics which have to be cooled or even heated depending on the ambient conditions and operating state. The rotary valve according to the present disclosure allows the components to be supplied with temperature control medium as required. Due to the proportional adjustability of the valve core, several components can be supplied simultaneously with partial volume flows of the temperature control medium. It is also conceivable that, by rotating the valve core, the channel structure is rotated in such a way that the flow directions of volume flows are reversed.

Preferably, the valve core is operatively connected to an actuator. In particular, it is conceivable that the actuator is designed as an electric motor. The actuator rotates the valve core, wherein the actuator is designed to continuously rotate the valve core. However, continuous in the sense of the present disclosure also means that the valve core can be adjusted in discrete steps. Accordingly, rotational angle adjustments in an interval from 0.5° to 20°, preferably from 1 ° to 15° and particularly preferably from 1.5° to 10° are understood to be continuous. The rotary valve is designed in such a way that an adjustment of the valve core by an angle of 20° causes a change of 50% in the volumetric flow rate flowing into a fluid opening or flowing out of a fluid opening.

Preferably, the valve core is adjusted in such a way that for each adjustment interval there is a change in the volume flow rate of the fluid flowing into or out of a fluid opening of at least 1% to a maximum of 20%, preferably of at least 2% to a maximum of 15%, particularly preferably of at least 3% to 12%. It is essential that the channel structure can have intermediate positions relative to the fluid openings.

The actuator can be designed as a stepper motor. A stepper motor is designed so that one revolution of the stepper motor is divided into a predetermined number of angular steps. This allows the position of the valve core to be detected with the stepper motor and the stepper motor can control specific positions of the valve core.

The valve chamber can be conically shaped. In this embodiment, the valve core is preferably congruent with the valve chamber and is conically shaped on the outside, in particular along the edges facing the chamber wall. This allows the valve core to be mounted in the valve housing in such a way that there is only a very small gap between the valve core and the valve housing, which reduces the risk of leakage.

The valve chamber is preferably delimited by a chamber wall and a chamber bottom, wherein the chamber wall surrounds the valve core, wherein the diameter of the chamber wall widens, starting from the chamber bottom, towards the receiving opening. Here, it is advantageous that the valve core is mountable into the valve chamber in a particularly simple manner. In this embodiment, the outer periphery of the valve core does not come into contact with the chamber wall until the valve core is fully pushed into the valve chamber. This simplifies the assembly of the rotary valve because the valve core and the valve housing do not touch each other until the valve core is fully pushed into the valve housing. This can also prevent components of the valve core, such as the channel structure, from being damaged during assembly.

The boundaries of the valve core on the side of the outer circumference can abut directly against the chamber wall of the valve housing. However, it is also conceivable that the boundaries of the valve core on the side of the outer circumference, in particular in the area of the channel structure, are provided with a sealing contour.

Preferably, the valve core is supported translationally in the valve chamber. In this embodiment, during operation, the valve core may perform a purely rotational movement, a purely translational movement or a superimposed translational and rotational movement. In a superimposed translational and rotational movement, the valve core is moved translationally, wherein the valve core is spaced apart from the chamber in the case of a conical design of the valve chamber and valve core. This creates a gap which allows the valve core to rotate relative to the valve housing with negligible friction.

An adjustment of the valve core is preferably carried out in such a way that, first, a translational movement is carried out, wherein the valve core is spaced apart from the chamber wall of the valve housing, then, a rotational movement of the valve core is carried out, so that the channel structure is aligned with the fluid openings in the desired manner, simultaneously, another translational movement can be performed, and finally, another translational movement is performed, wherein the valve core is reinserted into the valve housing in such a way that the outer circumference of the valve core abuts against the chamber wall of the valve housing with virtually no gap. On the one hand, this makes it possible to adjust the valve core with low wear and low friction. Furthermore, fluid can be transported via the openings of the valve housing and the channel structure of the valve core while avoiding leakage.

The valve housing may be surrounded by a collector. In this case, the collector can simultaneously form the outer wall of the valve housing. There may be a gap between the chamber wall, which is formed from the valve housing, and the collector. This makes the rotary valve particularly light on the one hand, but also mechanically stable on the other.

The valve housing and/or the valve body may be formed as an injection molded part. As a result, both the valve housing and the valve body can be manufactured in a cost-effective manner. The collector can be made of polymer material and designed as a blow-molded part. This allows the collector to have a complex outer geometry, but at the same time be cost-effective to manufacture.

The valve housing, the valve body and/or the collector are preferably made of plastic. Preferably, an injection moldable thermoplastic material is used. This results in a rotary valve that can be manufactured in a cost-effective manner. Preferred materials for the valve housing and valve core are selected from plastics such as polyoxymethylenes (POM), polyphenylene sulfides (PPS) or polyamides (PA). The plastics may be provided with additives, for example a fiber reinforcement based on glass fibers. The selector shaft is preferably formed of fiber-reinforced plastic material. Alternatively, the selector shaft can also be formed of metallic material. The collector is preferably formed of polypropylene (PP). Insofar as the valve core is provided with a sealing contour on the side of the outer circumference in the region of the channel structure, it is in particular conceivable that the sealing contour is formed from thermoplastic elastomer and the valve core is produced by two-component injection molding.

The fluid openings are preferably designed as connecting pieces. The connecting pieces are suitable for accommodating fluid lines in the form of pipes and/or hoses. These can then be easily and cost-effectively connected to the rotary valve.

The valve core can be provided with a sealing contour along the edges associated with the valve housing. This prevents leakage between the valve core and the valve housing. The sealing contour can be produced particularly easily and cost-effectively if the valve core is designed as a two-component injection molded part made of plastic. In this embodiment, the sealing contour can be firmly formed onto the valve core in one step with the manufacture of the valve core.

A temperature control circuit according to the present present disclosure comprises at least one rotary valve of the type described above. In such an arrangement, the temperature control circuit can control the temperature of one or more components of an electric vehicle, for example a rechargeable battery, power electronics or a line or connector component. Such components exhibit optimum performance only within a limited temperature interval and must be heated or cooled accordingly, depending on ambient conditions and performance requirements.

Accordingly, the temperature control device may comprise a heating device and a cooling device in addition to a conveying device. The components whose temperature need to be controlled as well as a heating device and a cooling device are controlled via the rotary valve. Due to the proportional adjustability, it is not only possible to pass or divert the volume flows, but also to vary them. This allows the volume flows for each component to be adjusted as required.

### BRIEF DESCRIPTION OF THE DRAWINGS

Some embodiments of the rotary valve according to the present disclosure are explained in more detail below with reference to the figures. These show, each schematically:

FIG. 1 a sectional view of a rotary valve;

FIG. 2 the rotary valve in three-dimensional, sectional view;

FIG. 3 the valve core of the rotary valve in detail;

FIG. 4 the valve housing of the rotary valve in detail;

FIG. 5 the collector of the rotary valve in detail;

FIG. 6 a side view and top view of a rotary valve in a first position;

FIG. 7 a side view and top view of a rotary valve in a second position;

FIG. 8 side view and top view of a rotatory valve in a third position.

### DETAILED DESCRIPTION

The figures show a rotary valve 1 as part of a temperature control circuit of a device to be air-conditioned. In the present embodiment, the rotary valve 1 is used in electromobility applications as part of the temperature control circuit of an electric vehicle. In this case, the rotary valve 1 is integrated into a temperature control circuit of an electric motor drive of an electric vehicle and directs volume flows of the medium conducted in the temperature control circuit to the batteries and electric motors as well as to the power electronics. The rotary valve 1 can be used to modify temperature control medium flows of the temperature control circuit.

In this context, it is conceivable to modify the volume flow of the temperature control medium, that is, to increase or decrease it. Furthermore, the direction of flow of the temperature control medium can be changed by rotating the valve core 7. In this respect, the rotary valve 1 according to the present disclosure forms a directional control valve through which various components of the equipment to be temperature-controlled can be individually and specifically supplied with temperature control medium and, if necessary, also separated from the temperature control medium flow.

Depending on the ambient temperature and power requirements, for example, a temperature control medium flow can initially be directed exclusively to the batteries, where it can cool or heat the batteries depending on the ambient temperatures. For high power requirements, a flow of coolant can be directed to the power electronics and also to the electric motors to cool these components. The modification of the coolant flow takes place by means of the rotary valve 1. In this case, the rotary valve 1 can replace several solenoid valves, so that the temperature control circuit can be produced in a cost-effective manner.

The rotary valve 1 comprises a valve housing 2 having a valve chamber 3, wherein the valve chamber 3 has a chamber wall 4. Six fluid openings 5 are provided in the chamber wall 4. The valve chamber 3 is formed to be rotationally symmetrical and has a substantially conical chamber wall 4. A receiving opening 6 is provided on the end face side of the valve chamber 3 via which a valve core 7 is inserted into the valve chamber 3. The valve core 7 is provided with a channel structure 8 which interacts with the fluid openings 5. The valve core 7 is supported in a rotationally movable manner in the valve chamber 3. Depending on the position of the valve chamber 3 and the channel structure 8 aligned with the fluid openings 5, different transport directions result for the fluid flowing in and out via the fluid openings 5.

The valve housing 2 is surrounded on the outside by a collector 14. The valve housing 2, the valve core 7 and the collector 14 are made of a thermoplastic material. The valve housing 2 and the valve core 7 are formed as injection molded parts. The collector 14 is formed as a blow molding part.

The fluid openings 5 are designed as connecting pieces. In this regard, a tubular portion of the fluid openings 5 extends into the collector 14. The collector 14 has corresponding sections, also formed as connecting pieces. These are designed to accommodate pipelines or hoses.

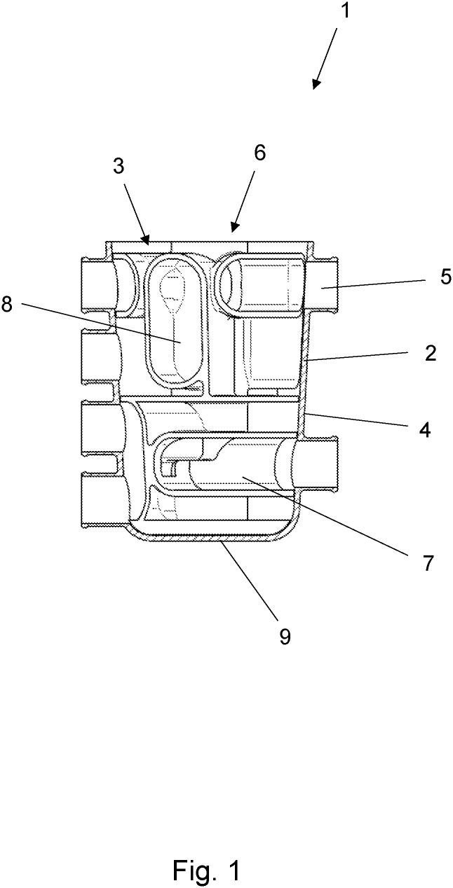

FIG. 1 shows a sectional view of the rotary valve 1 according to a first embodiment. The valve chamber 3 is conically shaped and the valve core 7 is congruent with the valve chamber 3 on the outer circumference and is thus also conically shaped. The valve chamber 3 is delimited by the chamber wall 4 and a chamber bottom 9. The chamber wall 4 surrounds the valve core 7, wherein the diameter of the chamber wall 4 widens, starting from the chamber bottom 9, in the direction of the receiving opening 6. To adjust the valve core 7 and to rotate the channel structure 8 relative to the fluid openings 5, the valve core 7 can be moved both translationally and rotationally relative to the valve housing 2.

In this case, the valve core 7 is operatively connected to an actuator. The actuator causes the valve core 7 to rotate and, in the present embodiment, can perform a superimposed rotational and translational movement. The translational movement creates a gap between the valve housing 2 and the valve core 7 which allows the valve core 7 to rotate relative to the valve housing 2 with low friction. In the present embodiment, the actuator is an electric motor in the form of a stepper motor. The actuator allows the valve core 7 to be rotated continuously in both directions, so that the flow-conducting connection between the channel structure 8 and the fluid openings 5 can be changed proportionally by rotating the valve core 7. The actuator is designed in such a way that the valve core 7 can be adjusted in intervals or rotation angle steps of 2°. An adjustment by a rotation angle step of 2° results in a change of the fluid flowing through the fluid openings by 5%.

As a result, the channel structure 8 of the valve core 7 can be rotated such that fluid channels are fully or only partially in flow communication with the channel structure 8. Accordingly, fluid openings 5 can be selectively brought into flow-conducting communication with each other by rotation of the valve core 7. This allows the flow of temperature control medium to be divided into partial flows, for example, which are directed via the fluid openings 5 toward various components of an electric vehicle.

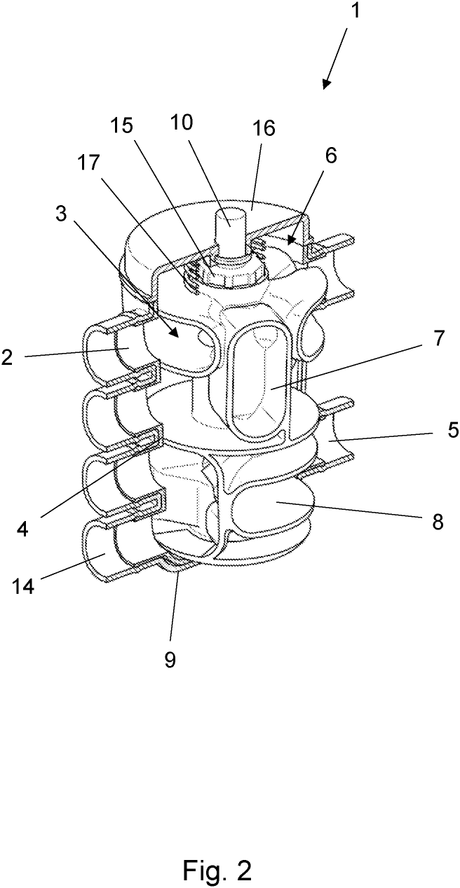

FIG. 2 shows a sectional view of the rotary valve 1. According to FIG. 2, the valve chamber 3 is conically shaped. The valve core 7 is congruent with the valve chamber 3 on the outer circumference side and is thus also conically shaped. The valve chamber 3 is delimited by the chamber wall 4 and a chamber bottom 9. The chamber wall 4 surrounds the valve core 7, wherein the diameter of the chamber wall 4 widens, starting from the chamber bottom 9, in the direction of the receiving opening 6.

The valve core 7 is supported both rotationally and translationally in the valve chamber 3. To adjust the valve core 7 and to rotate the channel structure 8 relative to the fluid openings 5, the valve core can be moved both translationally and rotationally relative to the valve housing 2.

The receiving opening 6 of the valve housing 2 is closed by a cover 16, wherein a selector shaft 10 projects through the cover 16. The selector shaft 10 is non-rotatably connected to the valve core 7. For this purpose, a rotation element 15 is formed from the selector shaft which engages in a recess 21 provided in the valve core 7. On the side of the outer circumference, the rotation element 15 has teeth which engage congruent teeth formed in the inner circumference of the recess 21, thereby enabling torque to be transmitted from the selector shaft 10 to the valve core 7. Between the cover 16 and the valve core 7, a spring 17 is arranged which presses the valve core 7 onto the chamber bottom 9.

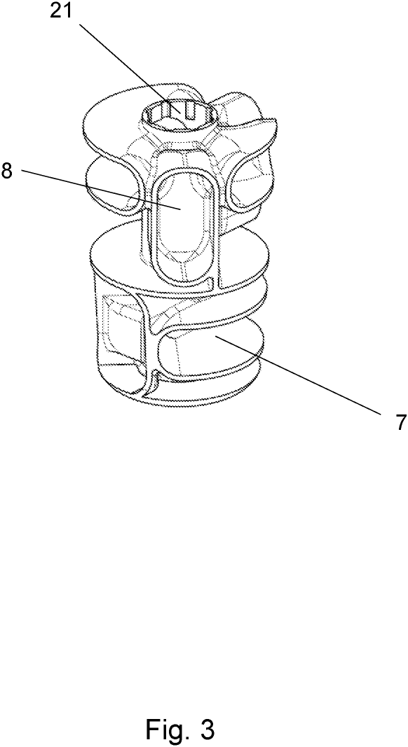

FIG. 3 shows the valve core 7 of the rotary valve 1 according to FIG. 2 in detail. The recess 21 with the teeth provided in the valve core 7 can be seen. The valve core 7 is provided with a sealing contour of thermoplastic elastomer in the area of the edges facing the valve housing 2. The valve core 7 is designed as a two-component injection molded part made of plastic.

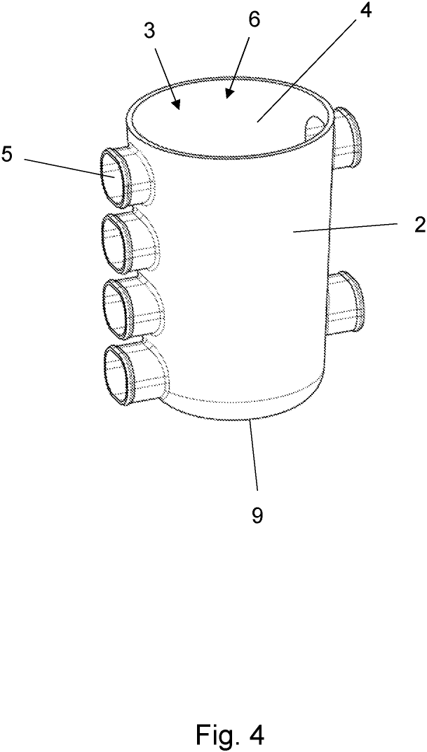

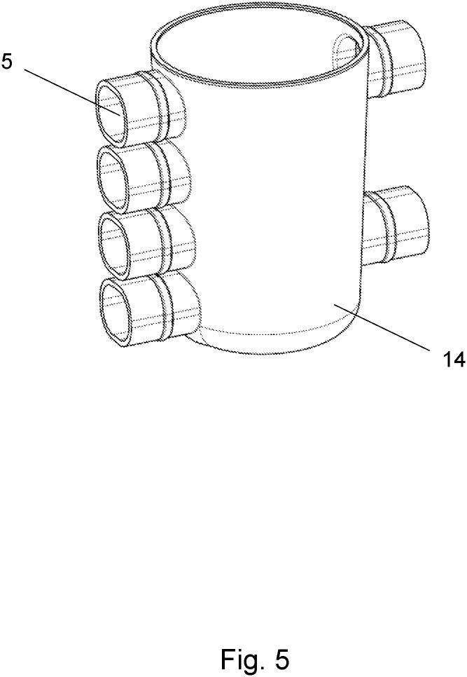

FIG. 4 shows the valve housing 2 of the rotary valve 1 in detail, and FIG. 5 shows the collector 14 of the rotary valve 1 in detail.

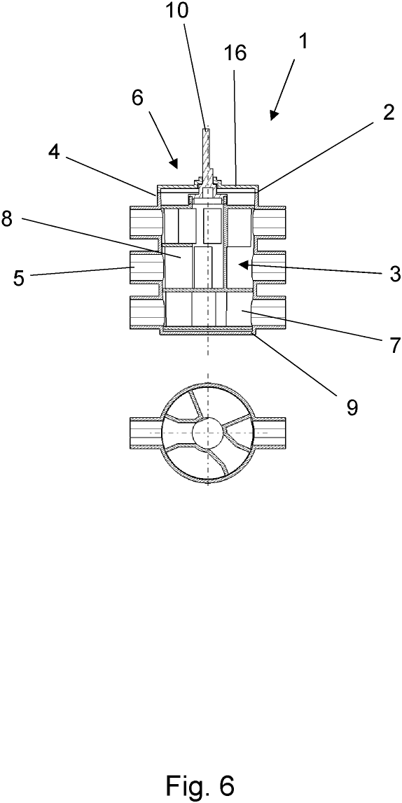

FIG. 6 shows an embodiment of a rotary valve 1 which, with regard to its components, is designed in a comparable manner to the rotary valve 1 shown above. In the rotary valve 1 shown here, the valve core 7 is continuously rotatable, so that the valve core 7 can have any angular position relative to the valve housing 2. The rotary movement of the valve core 7 is performed by means of an actuator in the form of a stepper motor arranged at the selector shaft 10. The upper illustration shows a side view in section and the lower illustration shows a top view in section, wherein the section plane passes through the upper fluid openings 5.

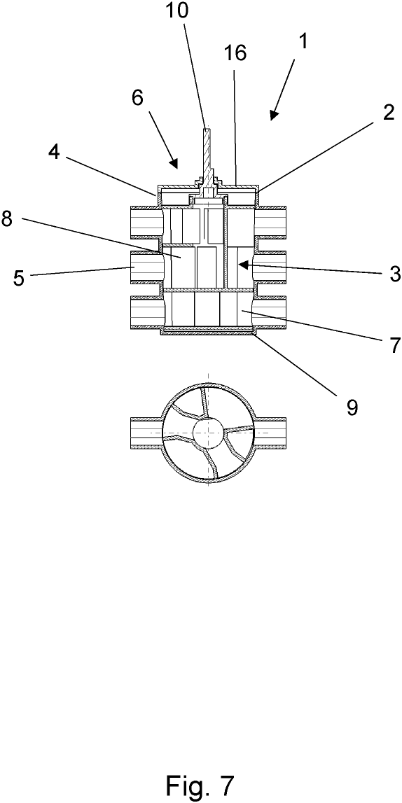

In the present embodiment, the valve core 7 is provided with a channel structure 8, wherein a channel section passes through the central axis of the valve core 7. This makes it possible, for example, to direct a volume flow between fluid openings 5 arranged one above the other. In the position shown in FIG. 7, the valve core 7 is rotated by zero degrees, which can be seen in particular in the lower illustration. In the lower illustration, it can also be seen that the channel structure 8 of the valve core 7 is completely open to the fluid opening 5 on the left-hand side, wherein temperature control medium flowing in via this fluid opening 5 in the direction of the channel section reaches the area of the central axis. Likewise, the channel structure 8 is completely open to the fluid opening 5 on the right-hand side. The rotary valve 1 shown here forms a ⅚-way valve.

FIG. 7 shows the rotary valve 1 according to FIG. 6, wherein the valve core 7 is rotated by 15 degrees. It can be seen that the fluid openings 5 are now only partially aligned with the channels in the channel structure 8, so that the volume flow rates are reduced compared to the position shown in FIG. 6. Furthermore, it can be seen that the temperature control media flowing in via the right fluid channel 5 and the left fluid channel 5 mix in the channel structure 8 and flow together in the direction of the channel section in the central axis.

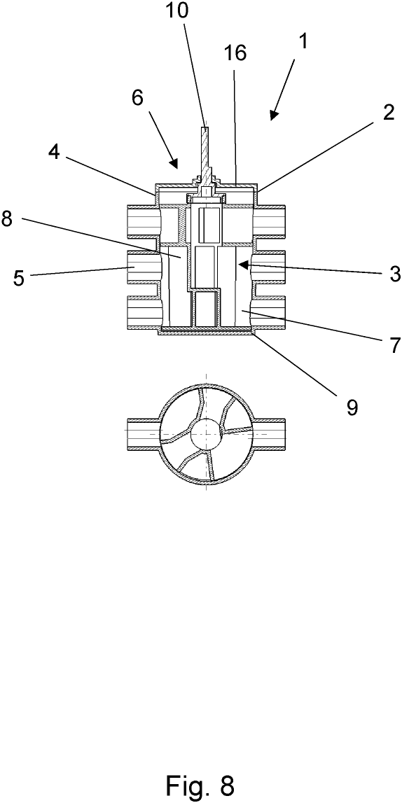

FIG. 8 shows the rotary valve 1 according to FIG. 6, wherein the valve core 7 is rotated by 105 degrees. It can be seen that the fluid opening 5 on the left-hand side is only slightly aligned with the channel structure 8, so that only a small volume flow can enter the valve core 7 via the left fluid opening 5. In contrast, the fluid opening 5 on the right-hand side is almost completely aligned with the channel structure 8. Also in this position, the temperature control media flowing in via the right fluid channel 5 and the left fluid channel 5 mix in the channel structure 8 and flow together in the direction of the channel section in the central axis.

1. A rotary valve, comprising a valve housing with a valve chamber, wherein the valve chamber has a chamber wall in which at least two fluid openings are provided, wherein the valve chamber has a receiving opening on the end face side, wherein the valve chamber accommodates a valve core, wherein the valve core is provided with a channel structure which interacts with the fluid openings, wherein the valve core is supported in the valve chamber in a rotationally movable manner, and wherein the valve core is continuously rotatable.

2. The rotary valve according to claim 1, wherein, by rotation of the valve core, the flow-conducting connection between channel structure and fluid openings is proportionally variable.

3. The rotary valve according to claim 1, wherein multiple fluid openings are provided in the chamber wall, wherein two or more fluid openings can be selectively brought into flow-conducting communication with one another by rotation of the valve core.

4. The rotary valve according to claim 1, wherein the valve core is connected to an actuator.

5. The rotary valve according to claim 4, wherein the actuator is designed as a stepper motor.

6. The rotary valve according to claim 1, wherein the valve chamber is conically shaped.

7. The rotary valve according to claim 6, wherein the valve core is conically shaped on a side of the outer circumference.

8. The rotary valve according to claim 6, wherein the valve chamber is delimited by the chamber wall and a chamber bottom, wherein the chamber wall surrounds the valve core, wherein the diameter of the chamber wall widens, starting from the chamber bottom, in the direction of the receiving opening.

9. The rotary valve according to claim 8, wherein the valve core is rotationally and/or translationally movable.

10. The rotary valve according to claim 1, wherein the valve housing is surrounded by a collector on the outside.

11. The rotary valve according to claim 1, wherein the valve housing, the valve core and/or the collector are formed of polymeric material.

12. The rotary valve according to claim 1, wherein the fluid openings are formed as connecting pieces.

13. The rotary valve according to claim 1, wherein the valve core is provided with a sealing contour along the edges associated with the valve housing.

14. The rotary valve according to claim 13, wherein the valve core is formed as a two-component injection-molded part made of polymeric material.

15. A temperature control circuit, comprising at least one rotary valve according to claim 1.
